(19) United States
(12) Patent Application Publication
(10) Pub. No.: US 2018/0315129 A1
(43) Pub. Date: Nov. 1, 2018

(54) Account Based Handset Protection Coverage

(71) Applicant: Asurion, LLC, Kansas City, MO (US)

(72) Inventors: Jeff Kulla, Kansas City, MO (US); Charles Laue, Kansas City, MO (US)

(73) Assignee: Asurion, LLC, Kansas City, MO (US)

(21) Appl. No.: 16/030,143

(22) Filed: Jul. 9, 2018

Related U.S. Application Data
(63) Continuation of application No. 15/245,877, filed on Aug. 24, 2016, now abandoned.
Application No. 15/245,877 is a continuation of application No. 14/968,010, filed on Dec. 14, 2015, now abandoned.
Application No. 14/968,010 is a continuation of application No. 14/218,381, filed on Mar. 18, 2014, now abandoned.
Application No. 14/218,381 is a continuation of application No. 13/906,047, filed on May 30, 2013, now abandoned.
Application No. 13/906,047 is a continuation of application No. 12/609,948, filed on Oct. 30, 2009, now abandoned.
Application No. 12/609,948 is a continuation of application No. 12/558,241, filed on Sep. 11, 2009, now abandoned.
(60) Provisional application No. 61/191,735, filed on Sep. 11, 2008.

(51) Int. Cl. G06Q 40/08; G06Q 30/04; G06Q 30/02; G06Q 30/06; G06Q 40/02; G06Q 30/00

(52) U.S. Cl. CPC G06Q 40/08; G06Q 30/04; G06Q 30/0231; G06Q 30/06; G06Q 30/012; G06Q 30/0283; G06Q 40/02

(57) ABSTRACT

Methods and means for device account based protection coverage are provided which allow for account holders to share a protection plan across a shared account, thereby covering a plurality of individual devices and discreet devices. Program users are able to manage their device protection in a manner more consistent with the way they use their device and services. Users are also able to purchase rate-tailored protection plans for all (or some) of the plurality of devices tied to the account, thereby facilitating cost-sharing of service fees with other members associated with the account. Account members can also share claims benefits across the protected group.

### FIELD OF THE INVENTION

The present invention relates generally to methods and means of providing device account protection, including but not limited to enhanced warranties, service contracts, insurance, etc., and in a particular though non-limiting embodiment to methods and means of providing a shared, account-based device protection program.

### BACKGROUND

Currently, device customers are limited to only a few options for protecting their investment, e.g., the options provided at the time of purchase of a new device (whether an original or replacement device). Regardless of the reason for purchase, customers are usually made aware of protection options available to cover the newly purchased device, examples of which include protection against lost, theft, malfunction, and damage.

So long as buyers purchase their devices from an authorized agent of a carrier/retailer, they are typically eligible to enroll for protection coverage within 15 days or so from the date of the device purchase.

The cost of such coverage varies, and is usually based on a combination of factors, such as the type of device purchased, and the type of coverage purchased, etc. In some instances, the cost of protection is automatically billed to the customer on a monthly invoice. The coverage is typically assigned to a single device registered to the customer's associated device identification number. This type of protection is sometimes referred to as Line Level Protection (hereafter “LLP”). Accordingly, if a customer has multiple devices, they would typically pay the premium associated with each device protected by the LLP.

At the time of a covered event, protected customers are usually eligible for a replacement device to be paid for through their protection provider. In a typical instance, the replacement process begins with a phone call to the protection program administrator. Once information is collected from the claimant, it is evaluated for eligibility. The covered event notification call may take several minutes or more to complete the process. Once a replacement request is approved, a service request fee payment is collected or applied to a customer's invoice, and the replacement is authorized for delivery. Replacement service request fees vary based on many factors including the type of device protected, replacement device, premium paid, type of loss, and the customer's loss history. The customer then receives the replacement device within a few business days, or, in some cases, by visiting an authorized carrier store to pick up the replacement device in person. Once the replacement shipment is received or picked up at a carrier/retailer store, the loss issue is resolved and the customer's protection account is adjusted to reflect the details of the completed claim. Most protection programs track individual customer claim activity during their coverage term, as well as the remaining number of claims available under the LLP. Generally, the carrier provides a maximum replacement benefit limit on a per-line, per-year basis.

Again, though, such coverage is limited to protection for only a single device. Nonetheless, this solution has proven to be a satisfying, long-standing value added service that works well for most consumers, and especially well for those owning only a single (or a few) devices. However, the device retail and service provider industry has evolved quickly and eccentrically over the past 5 years, and a large commercial aspect of the industry has emerged, and the number of individuals and families with multiple devices has grown exponentially. There is, therefore, a widespread but unmet need for policies that gather larger numbers of discrete devices into bundles for protection in a reliable, more effective, cost-efficient manner.

### SUMMARY OF THE INVENTION

A method for providing account based device protection is provided, the method including: bundling a plurality of discrete accounts associated with a plurality of individual devices; and protecting against loss factors associated with said bundled accounts across an account-based device protection program. In other embodiments, the method includes: automatically adding protection for new devices added to the bundled protection program. In further embodiments, the method includes: automatically removing protection for devices disconnected from the bundled protection program. In still further embodiments, the method further includes: sharing claims across the bundled protection program. In yet further embodiments, the method includes: sharing claim benefits across the bundled protection program.

In another embodiment, the method for providing account based device protection further includes: establishing an Internet web portal for bundled account-based protection management. In other embodiments, establishing an Internet web portal for bundled account-based protection management includes: providing a plurality of account level reporting tools. In another embodiment, establishing an Internet web portal for bundled account-based protection management further includes: providing tools for tracking claims and benefits across a bundled protection program. In other embodiments, establishing an Internet web portal for bundled protection account management includes: validating protected devices covered by the bundled protection program. In still another embodiment, establishing an Internet web portal for bundled protection account management includes: providing product and protection services information. In a further embodiment, account level and line level reporting are provided as customer account management tools.

In further alternative embodiments, the method for providing account based device protection includes: adding a line of service to a bundled account-based protection program at the time said line is first acquired. In a further embodiment, the method for providing account-based device protection includes: adding a line of service to a bundled protection program during a predetermined time period following the date on which a line is first acquired. An additional embodiment is the ability to add protection for devices remaining on an account after the some devices have been removed.

In yet a further embodiment, the method for providing account-based device protection includes: extending service provider contract commitment for any line of service in the bundled protection account.

In yet a further embodiment, the method for providing account-based device protection includes: replacing any device on any line of service in the bundled protection account.

In another alternative embodiment, the method for providing account-based device protection includes: issuing a single bill to a primary account holder of the bundled protection program. In another embodiment, issuing a single bill to a primary account holder of the bundled, account-based device protection further includes: billing on a single premium coverage basis. In other embodiments, issuing a single bill to a primary account holder of the bundled protection program further includes: billing on an added line coverage basis. In yet another embodiment, issuing a single bill to a primary account holder of the bundled protection program further includes: billing on a banded pricing basis. In yet another embodiment, issuing a single bill to a primary account holder of the bundled protection program further includes: discounting the total of all premiums at the bottom of the bill at a predetermined rate. In yet another embodiment, issuing a single bill to a primary account holder of the bundled protection program further includes: applying a discount at a predetermined rate based on the total number of devices protected, thereby resulting in a greater discount as the number of devices increases.

In still further alternative embodiments, the method for providing account based device protection coverage further includes: evaluating a claims request and authorizing issuance of a replacement device after determining whether one or more of a plurality of predetermined replacement criteria has been satisfied. In other embodiments, the method for providing account based device protection coverage includes: authorizing issuance of a replacement device via direct delivery to a customer. In another embodiment, authorizing issuance of a replacement device via direct delivery to a customer further includes: authorizing issuance of a replacement device via direct delivery on an expedited basis after determining whether one or more of a plurality of predetermined priority customer criteria has been satisfied. In yet another embodiment, authorizing issuance of a replacement device via direct delivery to a customer includes: authorizing issuance of a replacement device via pickup at an authorized retail dealer.

### DETAILED DESCRIPTION OF REPRESENTATIVE EMBODIMENTS

Methods and means for device account based protection coverage are described herein. In addition to providing account based coverage, the disclosed methods and means embody a process for making claims, and for designating coverage to specific accounts. Presently preferred embodiments allow for account holders' devices (e.g., wireless telephone, etc) to share a protection plan across a mutual account.

Typical embodiments of the Account Based Coverage (hereafter “ABC”) program allow customers to manage their device protection in a manner more consistent with the way they use their device and services. Further embodiments allow customers to purchase rate-tailored protection plans for all (or some) of a plurality of devices tied to the account, thereby giving account holders the ability to cost-share premiums with other members associated with the account. Still further embodiments allow account members to share claims benefits across the protected account.

One embodiment of an ABC system establishes protection at the primary account holder level at the time an account is either activated or renewed, or changed. In some embodiments, the customer benefits include one or more of the following non-exhaustive benefits selected from an associated benefits menu:
Automatic addition of coverage for new devices that are added to the account (though previously unprotected devices may still be subject to a waiting period before a claim for pooled benefits can be filed)
Automatic removal of coverage as devices disconnect from the account
One expense line item on the customer bill vs. multiple devices
Sharing of claims across the account allowing expanded coverage
Volume based pricing (similar to offers to the account based segment)
Lower customer costs due to reduced adverse selection
Expanded services including specialized claim and enrollment handling team with same day delivery
Options for service request fee payment, device delivery/pick up
Status updates regarding enrollment and claim activity including delivery
Web portal for account protection management including account level reporting tools, claim counts, claim tracking, protection product services description and validation of protected devices
Replacement inventory on site at the protected party's location

Similar to current protection plans, some embodiments of the ABC plan would be presented by the authorized representative at the time an account is created. However, other embodiments vary from existing protection plans because new account based plans are eligible for coverage at a time of account creation as well as within an eligible enrollment period that follows. In some embodiments, existing customers, either with or without device protection in force, experience an eligible event that triggers the re-opening of the enrollment eligibility window, and then convert their policy to account based coverage to cover previously unprotected devices on the account.

Example embodiments of such eligible events include:
Adding a new device to the account
Upgrading or replacing a device on any of the devices on the account
Extending the carrier contract for any of the devices on the account
Adding a new device and associated line of service on an existing account (e.g., adding a fourth family line of service to a three line account, thereby expanding devices on a small, medium or large business account)
Removal of a device and associated line of service from an existing account (e.g., removing the 4^{th} line of service on the account enabling coverage for unprotected devices on the account, thereby ensuring the opportunity to enroll in the ABC program business account)

Embodiments of the ABC protection solution are constructed to maximize program flexibility by allowing varying device enrollment requirements, which in turn allows for specialized solutions and product differentiation between and amongst clients.

Typical embodiments of account enrollment include:
All or nothing coverage—All devices on the account must be protected in order to be eligible for account based coverage
Enroll at will—Any number of devices on the account can be protected under ABC

In some embodiments, the primary account holder is presented with the option to add ABC at the time the account is established. In other embodiments, the account holder is guaranteed that all subsequent devices added to the account will be covered automatically, thereby eliminating any concern of unprotected devices as the account grows. In still other embodiments, the account is adjusted to have the proper amount of coverage removed when devices are disconnected from the account.

Several embodiments of the ABC plan allow an account holder to share claims across the account. Further embodiments allow the account holder to manage their device protection needs from a predetermined number of total shared claims allocated to the account instead of a fixed number of claims allocated to each line of service. Various embodiments of this latter feature expands protection by pooling the risk of the entire account (which requires all devices to be covered) and reducing the likelihood of certain higher-risk customers exceeding their annual claim allowance and subsequent cancellation of coverage.

Unlike current protection programs, the presently disclosed ABC system provides multiple billing methods that can apply in various combinations to a plurality of account types, representative embodiments of which include but are not limited to:
Single premium coverage which protects all devices on the account—A single charge on a regular frequency (day, week, month, quarter, bi-annual, annual) provides for a defined number of claims over a period of time for any number of devices on the account

Example (Illustrative):
X (program dependant) devices are covered each month, with an annual limit of Y (program dependant) claims shared across protected devices on the account
Add a line coverage—protects the first X number of devices for a fixed premium per line of service and a fixed number of replacements shared across the protected devices; incremental devices added to the account result in a reduction of rate per line based on volume of devices protected and increase the number of annual replacements allowed

Example (Illustrative):
First X devices cost a set fee each month, with annual limit of Y (program dependant) claims shared across the two devices; each additional line of service added to the account increases the monthly fee by a certain amount per line; in some embodiments, the number of annual shared claims is also increased by a predetermined amount
Banded pricing—protects all devices on an account for a set fee per month with shared claims. Banded pricing programs group primary accounts into pre-determined ranges based on the number of individual accounts enrolled by the protected party.

Example (Illustrative):
Organization A has 35 devices to cover and thus falls in a policy band covering 31-40 devices, with a monthly premium of $X and Y total claims available; protected parties may add Z more devices before entering the next price/claim tier
Bottom of bill discount—protects all devices on the account. Premium per line of service is charged and totaled at the account level. A discount is applied to the total of all premiums based on a pre-determined amount or based on total number of devices.

Example (illustrative):
Organization A has a number of devices to cover with a set monthly premium and set number claims available; at the bottom of the bill a discount is applied at a predetermined rate, thereby resulting in a total premium charge less than that of an account where all devices are billed individually and do not share claims; the discount rate may or may not increase based on the size of the account
Stepped discount by volume—protects all devices on the account. Premium per line of service is charged and totaled at the account level. A discount is applied to the total of all premiums based on total number of devices within a band. Premium total in each band added to premium total of adjacent bands for account total.

Example (Illustrative):
Organization A has a number of devices to cover and a set number of claims available; premium for the initial pre determined number of devices is billed at a set rate; premium for a second set of predetermined devices is billed at a lower predetermined rate; premium for a third set of predetermined devices is billed at an even lower predetermined rate.

Similar to current programs, certain embodiments of the ABC plan will replace a device at the time they experience a loss. In some embodiments, a phone call by the protected party allows a program administrator to review and approve the claim request. In alternate embodiments, the protected party contacts the program administrator through a web site so that the administrator can review and approve the claim request. In typical embodiments, the customer receives a replacement device via mail or an authorized carrier store upon payment of a service request fee. Once the replacement shipment is received or picked up at a carrier/retailer store, the loss issue is resolved and the customer's protection account is adjusted to reflect the details of the completed claim. Depending on the parameters of the program, coverage can provide a maximum benefit by account by year.

Alternate embodiments comprise a dedicated toll-free customer satisfaction number that is staffed with business-trained representatives for large business accounts. In one embodiment, replacement fulfillment for these customers occurs in an expedited manor, including same day and/or next day delivery of stock on hand at client locations for executive level replacements.

Other embodiments of the ABC plan leverage specific processes to manage the solution, including but not limited to:
Customer authentication—The program administrator creates a unique customer identification at the account level that is tied to the account number provided by the carrier in order to identify and manage account and line level details.
   In further embodiments, each device associated with a line of service on an account possesses a unique number that ties to the carrier-generated unique identification number, e.g., the account level identification number for an individual line is used to match the line to the account, and then track the history of each individual user on the account.
Velocity checks—The program administrator utilizes a combination of customer history, device, loss peril, shipment address, payment method and account size to measure, over time, a customer's activity in the Account Based Coverage program. This process helps identify potential program abuse and force immediate review by a specialized team prior to claim approval.
Active IMEI/ESN management—A specific data base maintains a list of device-unique identifiers (e.g., IMEI, ESN, etc.) associated with the program. In some embodiments, integrated systems share such information with carriers using like capable device in order to disallow the use of claimed device on the carrier program as well as disallow enrollment in our programs. Removal of a device identification number from a service provider's system requires proof of remanufacture from a qualified and approved remanufacturer.
Benefit management—The program administrators system monitors customer account activity using the carrier-generated unique identification numbers to monitor and manage the following elements of the program: enrollment eligibility, claim max benefits, correct billing of premium on the account
Shared claims—the account has a claim limit that allows the claim benefits to be shared across the account (e.g., X devices are registered and Y claims allowed (program dependant) and any combination of the registered devices can use the Y claims, etc.)

Fields of use appropriate for application of the above described invention include but are not limited to: wireless and cable services providers; electronic device and equipment retailers such as big box stores, cable services, data services, and other services for electronic equipment, etc. Devices within the context of the disclosure include but are not limited to: cell phones, data cards, laptops, computers, set peripheral boxes, televisions, other electronic equipment, etc.

The foregoing specification is provided for illustrative purposes only, and is not intended to describe all possible aspects of the present invention. Moreover, while the invention has been shown and described in detail with respect to several exemplary embodiments, those of ordinary skill in the art will appreciate that minor changes to the description, and various other modifications, omissions and additions may also be made without departing from the spirit or scope thereof.

1. A system for providing account based protection for a plurality of portable electronic devices, said system comprising: a processor disposed in communication with software, wherein said software is programmed to bundle a plurality of discrete lines associated with a plurality of individual portable electronic devices within a single account; and apply a plurality of predetermined loss factors associated with said bundled lines in order to assess risk associated with the account and thereby inform an operator of the system regarding a corresponding price structure for the single protection account.

2. The system for providing account based protection of claim 1, wherein said software is further programmed to recognize a prior customer election to automatically add protection for new portable electronic devices added to the bundled protection account.

3. The system for providing account based protection of claim 1, wherein said software is further programmed to recognize a prior customer election to automatically remove protection for portable electronic devices disconnected from the bundled protection account.

4. The system for providing account based protection of claim 1, wherein said software system is further programmed to recognize a prior customer election to share a predetermined number of claims across the bundled protection account.

5. The system for providing account based protection of claim 1, wherein said software is further programmed to recognize a prior customer election to share a plurality of claim benefits across the bundled protection account.

6. The system for providing account based protection of claim 1, wherein said software is further programmed to provide customers a plurality of tools for managing a bundled protection account.

7. The system for providing account based protection of claim 6, wherein said software is further programmed to provide customers a plurality of account level reporting tools.

8. The system for providing account based protection of claim 6, wherein said software is further programmed to provide customers tools for tracking claims and benefits across a bundled protection account.

9. The system for providing account based protection coverage of claim 6, wherein software is further programmed to validate that individual portable electronic devices are registered within the bundled protection account.

10. The system for providing account based protection coverage of claim 6, wherein said software is further programmed to provide customers product and protection services information upon request.

11. The system for providing account based protection coverage of claim 1, wherein said software is further programmed to recognize a prior customer election to add a line of service to a bundled protection account during a predetermined time period following the date on which a line is first acquired.

12. The system for providing account based protection coverage of claim 1, wherein said software is further programmed to remove a line of service from a bundled protection account after a predetermined time period following the date on which a line is first acquired.

13. The system for providing account based protection coverage of claim 1, wherein said software is programmed to issue a single bill to a primary account owner of the bundled protection program.

14. The system for providing account based protection coverage of claim 13, wherein said software is further programmed to bill a primary account owner on a single premium coverage basis.

15. The system for providing account based protection coverage of claim 13, wherein said software is further programmed to bill a primary account owner on an added line coverage basis.

16. The system for providing account based protection coverage of claim 13, wherein said software is further programmed to bill a primary account owner on a banded pricing basis.

17. The system for providing account based protection coverage of claim 13, wherein said software is further programmed to discount a plurality of predetermined charges on a bill after initial application of a predetermined rate.

18. The system for providing account based protection coverage of claim 13, wherein said software is further programmed to apply a predetermined discounted rate based on a total number of portable electronic devices protected on a bundled protection account.

19. The system for providing account based protection coverage of claim 1, wherein said software is further programmed to evaluate a claims request and initiate issuance of a replacement portable electronic device after determining whether one or more of a plurality of predetermined replacement criteria has been satisfied.

20. The system for providing account based protection coverage of claim 19, wherein said software is further programmed to initiate issuance of a replacement portable electronic device via direct delivery to a customer.

21. The system for providing account based protection coverage of claim 20, wherein said software is further programmed to initiate issuance of a replacement portable electronic device via direct delivery on an expedited basis after determining whether one or more of a plurality of predetermined priority customer criteria has been satisfied.

22. The system for providing account based protection coverage of claim 19, wherein said software is further programmed to initiate issuance of a replacement portable electronic device via pickup at an authorized retail dealer.

23. The system for providing account based protection coverage of claim 1, wherein said software is further programmed to extend a service provider contract commitment for any line of service in the bundled protection account.

24. The system for providing account based protection coverage of claim 1, wherein said software is further programmed to authorize replacement of any portable electronic device on any line of service in the bundled protection account.

25. The system for providing account based protection coverage of claim 1, wherein said plurality of portable electronic devices further comprises a plurality of telephone handset devices.

26. The system for providing account based protection coverage of claim 1, wherein said plurality of portable electronic devices further comprises a plurality of personal digital assistants.

27. The system for providing account based protection coverage of claim 1, wherein said software is further programmed to identify individual portable electronic devices within said plurality of portable electronic devices and then register said individual portable electronic devices in association with a discrete device identification number.

28. The system for providing account based protection coverage of claim 27, wherein individual portable electronic devices within said plurality of portable electronic devices are identified and registered in association with a discrete line number.

29. The system for providing account based protection coverage of claim 27, wherein individual portable electronic devices within said plurality of portable electronic devices are identified and registered in association with a discrete account number.

30. The system for providing account based protection coverage of claim 1, wherein said said software is further programmed to collect pertinent data used to determine an associated protection coverage pricing model.

31. The system for providing account based protection coverage of claim 1, wherein said software is further programmed to compare a plurality of predetermined risk factors associated with detected risk events and user behaviors selected from a set of predefined risk events and user behaviors in order to mitigate payment of benefits in the event of customer fraud.

32. The system for providing account based protection coverage of claim 1, wherein said software is further programmed to amend an individual risk profile associated with a particular line holder in the event a risk event or user behavior is detected that correlates with a predetermined set of risk events or user behaviors.
